(19) United States
(12) Patent Application Publication
(10) Pub. No.: US 2008/0271850 A1
(43) Pub. Date: Nov. 6, 2008

(54) High-Pressure Gluing in a Fiber Mixer

(76) Inventor: Josef Stutz, Niederteufen (CH)

Correspondence Address: PEARNE & GORDON LLP, 1801 EAST 9TH STREET, SUITE 1200, CLEVELAND, OH, 44114-3108, US

(21) Appl. No.: 10/571,661

(22) PCT Filed: Sep. 12, 2003
(86) PCT No.: PCT/EP03/10142

§ 371 Date: Mar. 10, 2006

(51) Int. Cl. B05C 5/02; B27N 3/04

(52) U.S. Cl. 156/356; 427/222

(57) ABSTRACT

The invention relates to a method for gluing fibers or chips, in particular, wood fibers or wood chips by atomizing the glue and subsequently applying the atomized glue to the fibers or chips.

### BACKGROUND OF THE INVENTION

The invention relates to a method for gluing fibers that serve the purpose of producing a board from a derived timber product, as well as a apparatus for carrying out the method.

### DESCRIPTION OF THE PRIOR ART

In WO 03/013808 and in FIG. 3, a method for producing a board is illustrated in its overall context. Hardwoods and softwoods in the form of logs, branches and/or sawmill woods as well as industrial waste woods are used as raw materials. At first, the wood is shredded in a shredder 31 into woodchips with a size of 20×5 mm. These woodchips may, however, also come directly from the forest or from sawmills. They may be sieved in order to separate particles that are too small or large. When the woodchips are of the correct size, they may be washed in order to remove foreign bodies (in particular sand and soil) adhering to them. In this way, cutting tools as well as other tools are prevented from sustaining damage later during the production and processing method. Advantageously, saw dust is used which is put into a silo 32. The wood components are supplied from the shredder 31 as well as from the silo 32 to a funnel-shaped presteaming container by means of conveyor belts. The supply typically takes place in a ratio of about 6:4 (60% by weight chips, 40% by weight sawdust). In this manner, sawdust is also used. Thus, costs are lowered further. Resources of raw materials are being used sparingly. The proportion of chips should be predominant since fibers, and later on fiber mats that stabilize mechanically will be produced from them. A lower limit for the proportion of sawdust must therefore not be adhered to. The wood components are mixed, presteamed and warmed to 60° C. to 70° C. in the presteaming container 33. The wood components are then supplied to a cooker 34, for example, by means of a plug screw. In the cooker 34, the wood components are cooked for about 2 to 3 minutes at a pressure of 11 to 16 bar and at a temperature of 140° C. to 180° C. The pressure and temperature are selected such that a split into liquid and solid wood components takes place. The liquid components are separated from the solid ones and supplied to a pipe 36 that is connected in a gastight manner with the cooker 34. The solid wood components are supplied to a refiner 36 (refiner or defibrator). The refiner 36 typically comprises a stator and a rotor that are driven via a motor. Here, the solid wood components are broken up into fibers. The fibers that are, in one embodiment, mixed with sawdust, are pneumatically supplied to a drying tube 37. In the following, the term fibers will be used independently from this. In the drying tube 37, the fibers are dried at 160° C. to 220° C. Drying takes place relatively quickly and cost-effective since liquid wood components have already been removed. From the drying tube, the fibers arrive in cyclones 38. Here, the steam is separated. The fibers are guided out downwardly. At that time, the temperature of the fibers is typically 50° C. The fibers are then mechanically provided with glue in gluing devices 39 at comparatively low temperatures. The fibers that are subsequently glued have a temperature of typically 35° C. to 40° C. The glued fibers arrive in one or more viewing facilities 40. In one embodiment, the viewing facilities 40 comprise heating devices for heating the fibers to 55° C. to 60° C. The increase in temperature is advantageous in a case where boards are to be pressed at temperatures of, for example, 80° C. In this manner, the pressing step can be expedited since the desired temperature does not have to be reached solely by means of the heated press. Shorter pressing times lead to greater production capacities or smaller acquisition costs for the employed presses with the revolving belts, since in this case, they may be shorter. Also, less space is needed for such presses. This saves more costs. The pre-glued fibers are supplied to one or more separation devices 41. From the separation devices 41, the pre-glued fibers come to a scattering station 42. The scattering station 42 dispenses the pre-glued fibers onto a conveyor belt. The conveyor belt brings the fibers to a pre-press 44. Here, the fibers are pre-pressed and thus, compacted. The pre-press comprises revolving belts between which the fibers are supplied and pressed in the process. Then, the fibers run through a forming line 45 that has various devices ensuring that the fibers are present in the desired form. The forming line in one embodiment leads to a steaming device 46. Here, the fibers are steamed from above and/or below. The fibers can be split parallel relative to the conveyor belt and thus steamed “within”. Finally, the fibers arrive at the main press 47 which consists of two revolving steel belts that are pressed together. Here, pressing takes place at, for example, 80° C. Then, the boards are sawed by means of a sawing device 48 and are brought to a holding device 49. In the holding device, the boards are held so that they do not touch. Thus, the boards are cooled. The separated liquid components that were supplied to the pipe 35, are being cooled within the gastight system. When these liquid components have been cooled sufficiently, they are either disposed of or supplied to the gluing device 39. Then, the boards are further processed into, for example, panels. The boards are then, for example, coated with papers and the system of layers supplied to a press. The system of layers is pressed in the press at temperatures above 150° C., for example, at temperatures of between 180° C. and 230° C. The resins used then harden. The board is sawed up further and provided with coupling elements by milling. The panels can serve as covering walls or floors. If they are used as floor covering, the panels are provided with an abrasion-resistant transparent layer on the top side of the decor.

WO 03/013808 discloses gluing of already dried fibers forming fibers to form a mat. Glue is then sprayed onto this mat. In this way, the glue comes on the fibers in the shape of droplets. A gluing device for applying glue onto fibers together with the subsequent manufacture of fiberboards is known from printed publication EP 0 744 259 A2. A method for the production of boards from a derived timber product can be seen in printed publication U.S. Pat. No. 5,554,330. Printed publication GB 791,554 discloses a method for mixing solid and liquid components. An apparatus for continually gluing wood chips emerges from printed publication DE 41 15 047 C1. Continuous mixing of chip-like and fiber-like substances with binding agents can be seen in printed publication DE-OS 1956898. Printed publication WO 98/37147 discloses obtaining glue from wood components. Pre-steaming methods are described in printed publications DE-OS 44 41017, US 11 17 95 as well as in the Danish patent application No. 0302/97.

### OBJECT OF THE INVENTION

It is the object of the invention to create a method by means of which high-quality boards of the kind mentioned at the beginning can be produced in a cost-effective manner. A further object of the invention is providing an apparatus for carrying out the method.

### SUMMARY OF THE INVENTION

The object of the invention is solved by means of one of the claimed methods. An apparatus for carrying out the method comprises the features of the independent claim. Advantageous embodiments result from the dependent claims.

According to the invention, the glue is applied onto the fibers at relatively low temperatures of preferably 20° C. to 40° C. In contrast to the prior art as it is known from WO 03/013808, glue is not only sprayed on but is atomized and/or nebulized prior to application on the fibers. Instead of comparatively large drops, the glue reaches the fibers in atomized form.

According to the invention, the atomization works in particular by conveying glue under very high pressure until it exits via nozzles. The glue then exits from high-pressure nozzles at very high pressure. The exits pressure at that time is preferably 15 bar to 250 bar, particularly preferably 40 to 90 bar. Preferably, the flow rate per nozzle is about 1.3 to 1.4 l/min in order to achieve high flow rates, on the one hand, and, on the other hand, to accomplish a nebulization within the sense of the invention.

In an advantageous embodiment of the invention, compressed air is supplied in addition to the glue in order to ensure, given relatively high discharge volumes of 1.3 l/min to 1.4 l/min per nozzle, that fringe areas of the discharge cone from the nozzles are also nebulized within the sense of the invention. The compressed air is supplied to the nozzles at a pressure of, for example, 2 bar. At lower flow rates of less than 1.3 l/min, it is, as a rule, not necessary to supply compressed air additionally in order to achieve the desired nebulization also in fringe areas.

By applying the glue in nebulized form an improved distribution of the glue on the fibers is achieved successfully. Therefore, the amount of glue applied onto the fibers per unit of time can be increased over the prior art, There is no danger of a non-uniform distribution leading to quality defects in the product.

An acceleration of production decreases the production costs. This is the case in particular, when glue exits at more than 1 l/min, preferably at more than 1.3 l/min. Such large exiting amounts, especially, could not be realized in the prior art since otherwise a significant loss of quality in the finished products occurs due to so-called glue stains. In contrast, the more uniform distribution achieved by nebulization ensures a high quality of the manufactured products.

The water content in the glue can be decreased over the prior art, namely in particular when using a glue consisting entirely or predominantly of urea resin. Thus, the proportion of glue in the glue-water-mixture may now be 45 to 65% by weight. Preferably, the content of glue is about 50 to 60% by weight. If the fibers provided with glue are pressed, the glue will harden more quickly. In this manner, the speed of production can be increased further and thus production costs can be decreased further.

Advantageously, the high pressure of the glue is generated by a high-pressure-pump whose revolutions per minute can be adjusted. By adjusting the revolutions per minute, the degree of atomization of the glue can advantageously be set very exactly. In contrast to the prior art, a very sensitive facility for dosing and optimizing during the application of glue is provided. The ratio of fibers to applied glue can thus be optimized further. Production costs can be lowered further by minimizing the proportion of glue because the proportion is a significant part of the production costs.

The amount of the glue required for the production of the boards is reduced by the application of the glue on the wood components in nebulized form only after drying.

The “right” ratio of the solid wood components to glue is a decisive quantity for effecting suitable gluing of fibers or chips. Therefore, according to the invention, the solid wood components are supplied to a conveyor scale prior to gluing in an embodiment of the method. On the conveyor scale, the solid wood components are transported further on the one side by means of a revolving conveyor belt, on the other side, they are weighed. In this way, information is obtained about which amount of glue is to be added to the solid wood components of the wood in the subsequent step.

The solid wood components are transferred to the subsequent device by means of the conveyor scale. In one embodiment, possible fluctuations in the weight of the supplied solid wood components are detected, registered and stored during transport. These data are processed and can serve as correcting quantity for the amount of glue that is subsequently applied to the solid wood components.

In one embodiment of the invention, the transport speed of the conveyor scale is controlled such that a uniform amount of solid wood components is supplied to the subsequent gluing device (device in which the solid wood components are provided with glue). Thus, by a change of speed of the infeed, a constant amount of material is supplied to the subsequent devices. The detection of the weight of the solid wood components that can be present in the shape of fibers or chips may take place in minute steps and makes a uniform supply of the solid components with an accuracy of, e.g., ±1% possible.

It is not easy to provide the solid wood components with glue in a suitably uniform manner, in particular when the solid wood components are present in the form of fibers. Fibers tend to bunch together like cotton wool. It is then difficult to distribute the glue uniformly on the fibers. In one embodiment of the invention, gluing therefore takes place in a mixer in which glue and solid wood components are mixed with each other.

After the drying of the solid wood components they are distributed evenly in one embodiment of the invention and a sort of curtain or mat is formed. This is the case in particular when the solid wood components are present in the shape of fibers because from them, a mat or a curtain may be formed readily. Glue is subsequently nebulized and is brought onto the curtain in nebulized form.

By forming a curtain a uniform distribution of the glue on the solid wood components is achieved. This the case particularly when the solid wood components are present in the form of fibers.

A curtain or mat formed of solid wood components is introduced into the mixer in one embodiment. The curtain or mat is supplied the mist of glue via the high-pressure-nozzles. Then, the curtain or mat is guided through the mixer, preferably without any contact. By the contact-free execution, the solid wood components are advantageously prevented from adhering on walls. Problems connected with dirt and the costs connected therewith are thus reduced.

The glue is blown into the dried solid wood components of the wood in nebulized form, in particular at a temperature of 35° C. to 70° C., preferably at a temperature of up to 60° C. In this manner, it is accomplished that the glue gets a dry outer skin. Thus, it is activated minimally. Thus, it is achieved in an improved manner that the subsequent mixture of solid wood components and glue does not stick to transport devices and equipment, such as for example inside the mixer.

In one embodiment of the invention, the mist of glue is nebulized together with warmed compressed air, and this mist is added to the dried solid wood components, i.e., for example, fibers and chips. The warm air, which is introduced together with the glue and the dried solid wood components into the mixer, for example via a cabin, activates the glue a little on its surface. In this manner, the adherence of solid wood components on subsequent devices, such as for example walls of the mixer, is counteracted.

Reactive resins are preferably used as glue, i.e. resins having components that are able to form a network chemically. Examples of reactive resins are: solid or liquid phenol resins, amino resins such as, for example, urea resins, melamine resins, acrylic resins, epoxy resins and/or polyester resins.

A calender press is preferably used for the pressing of the fibers provided with glue, primarily for the production of boards having a thickness of less than 10 mm. First of all, it was found that the gluing according to the invention is particularly well-suited especially in the production of boards with the specified thickness. On the other hand, a calender press with a revolving pressing belt as disclosed, for example, in DE 20303207U1, makes particularly high processing speeds possible. In connection with the gluing according to the invention, the high processing speed is particularly advantageous in order to process the unusually well-distributed glue very quickly so as to avoid an undesired premature activation of the glue.

### BRIEF DESCRIPTION OF THE DRAWINGS

The invention will be illustrated further by means of the following figures.

FIG. 1 shows a section through a conveyor scale 1 and a subsequent mixer 2. As indicated by the arrow 3, dried fibers that were produced from woodchips are supplied to the conveyor scale via an opening of a housing 4 of the conveyor scale 1. An incline 5 directs the arriving fibers onto the belt of the conveyor scale.

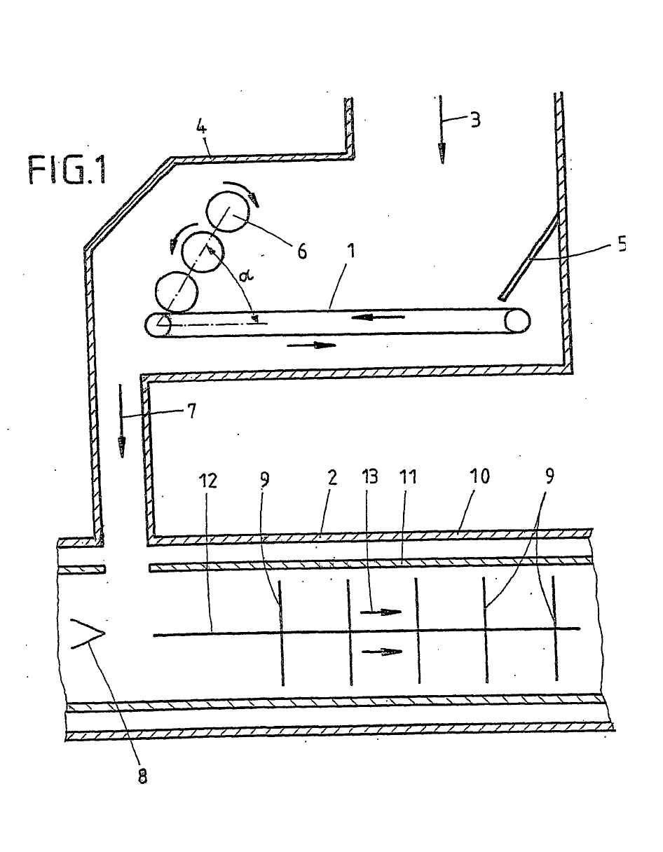

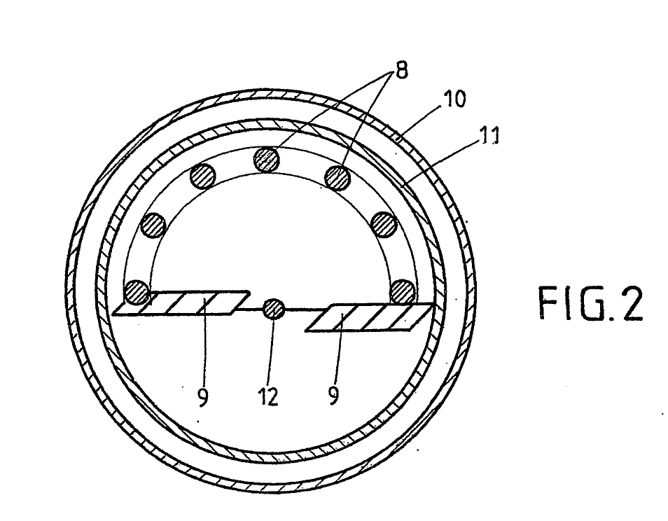

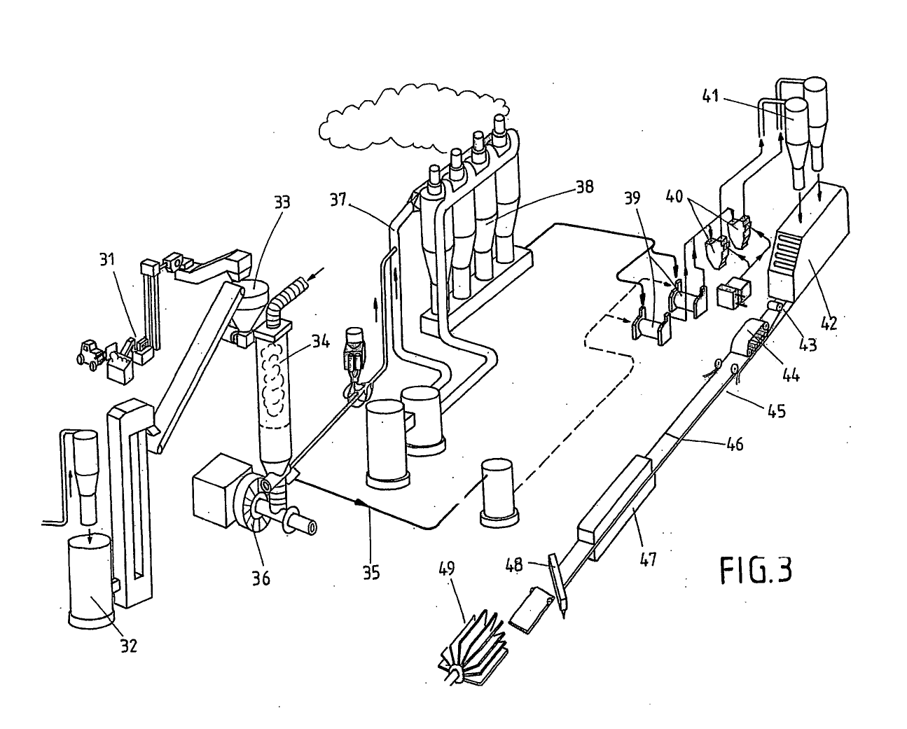

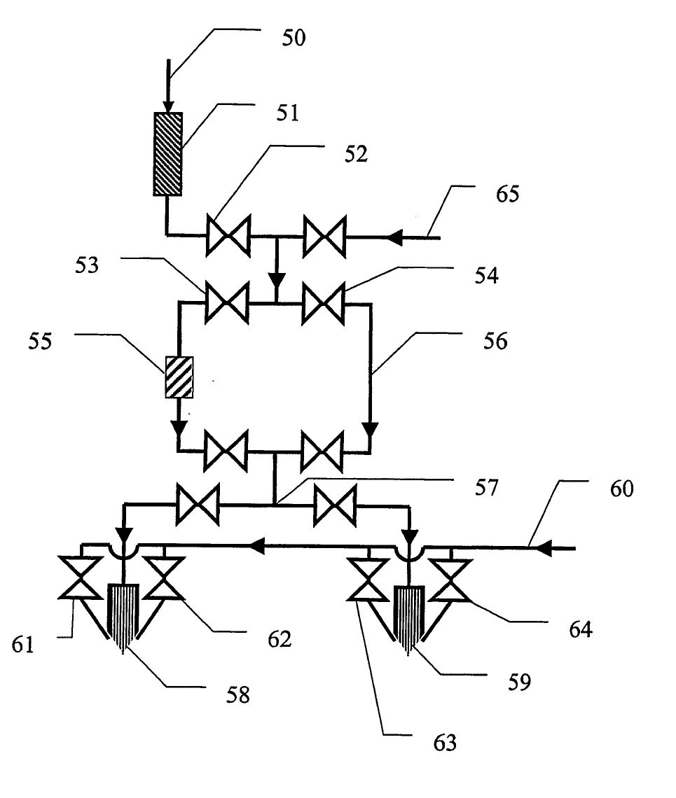

### DETAILED DESCRIPTION OF THE PREFERRED EMBODIMENTS

The conveyor scale detects and controls the amount of material that is transported in the direction of the three rollers 6. The three rollers 6 are arranged above one another and offset with regard to one another so that, together with the conveyor scale 1, they enclose an acute angle Alpha. The fibers located on the conveyor scale arrive in this acute angle. They pass the rotating rollers 6. Here, a curtain is formed from the fibers which, due to gravity, is transported further in a vertically downward direction along the arrow 7. Thus, the curtain comes into the mixer 2, namely between a plurality of nozzles 8 and tools 9.

The mixer consists of a tube-shaped housing. The housing is formed by a double wall 10 and 11. An axis 12 on which the tools 9 are attached is arranged centrally in the interior of the housing. A tool 9, together with the axis 12, encloses a right angle. Four rudder blade-like tools 9, respectively, are combined in a star-shaped manner. Several of these combined tools are attached on the axis 12 at regular distances. The front area into which the curtain consisting of fibers is brought, is free of tools. It is thus ensured that there is a sufficiently large distance between the tools 9 and the nozzles 8. This distance is provided so that glue that exits from the nozzles 8 does not directly impinge on the tools during operation.

The diameter of the housing of the mixer corresponds to the width of the opening via which the curtain consisting of fibers is introduced into the mixer. The width of the curtain is adapted to the width of the opening.

The high-pressure nozzles 8 are arranged in a semi-circle shape around the axis 12 in an upper area and are supplied both with glue in the range of 40 to 90 bar and with compressed air. The high-pressure nozzles used are formed as single-media nozzle or also as two-media nozzle, if a nozzle is to be supplied both glue as well as compressed air. The pressure of the glue of 40 to 90 bar is moved in a swirl-shape during the exit from the nozzle. By leaving the very narrow opening slot provided, the exiting glue “explodes” to form a mist. The nozzles are constructed such that glue is still being nebulized even at a pressure of 250 bar. The glue pressure is provided by a pump whose power can be controlled, namely in particular by adjusting the revolutions per minute.

In this way it can be achieved that, on the one hand, the curtain is uniformly provided with misty glue, and on the other hand, that the nebulized glue exiting from the nozzles 8 does not directly impinge on parts of the mixer. A distance is arranged between the nozzles 8 and the housing 10, 11, so that a kind of annular gap is formed. Air which ensures additionally that a mist of glue is created is sucked above this annular ring. The curtain provided with glue (in other words: a mat formed entirely or partly of fibers) is transported through the airflow in a direction parallel to the axis 12 through the mixer 2. The axis, and thus, the tools 9, rotates during the transport. In the process, the glue is further mixed with the fibers. A cooled liquid is introduced between the two walls 10 and 11 of the double wall in order to create a layer of condensation water in the interior of the mixer, on its interior walls.

In FIG. 2, a top view onto the mixer, parallel to the axis 12, is shown. For reasons of clarity, only two tools 9 are drawn in. FIG. 2 illustrates in particular the single-row, semi-circle-shaped arrangement of the nozzles in the upper area.

In particularly advantageous embodiments, the invention comprises one or more steps that are disclosed by FIG. 3 in conjunction with the associated drawing.

In FIG. 4, the basic arrangement with a high-pressure pump for the glue together with a supply to a nozzle is illustrated in more detail. Glue is supplied to a pump 51 via a line 50. The power of the pump can be adjusted. Glue is transported further from the pump 5, then passes a first stop valve 52 and finally arrives at the stop valves 53 and 54. If the glue passes the stop valve 53, it then flows through a flow rate meter 55. This serves the purpose of monitoring and/or controlling the amount of glue transported. Alternatively or additionally, the glue can be piped through a parallel line 56 in order to make large flow rates possible. Via further stop valves, the glue arrives at a distributor 57 from where the glue is directed in the direction of the high-pressure nozzles 58 and 59. The glue exits from the high-pressure nozzles 58 and 59 in a nebulized form.

In order to further enhance the nebulization, compressed air is guided laterally to the nozzles. The compressed air is supplied into a pipe 60, passes Stop valves 61,62, 63,64 that serve the purpose of the individual control of the compressed air that is supplied, and finally exits adjacent to the high-pressure nozzles 58 and 59. Herein, the compressed air is blown in the direction of the exiting mist of glue. Thus, the mist of glue is swirled further.

A further supply pipe 65 serves the purpose of supplying warm water with which the pipes, valves and nozzles can be cleaned. The high-pressure nozzles can be closed by means of compressed air in order to shut off the nozzles in case of a standstill of the system so as to avoid a discharge of glue that would then be undesired.

1-15. (canceled)

16. Method for gluing wood fibers comprising the steps of pressurizing and conveying glue to a plurality of nozzles, forming a curtain of said wood fibers and emitting the pressurized glue from the plurality of nozzles to atomize the glue and to apply the atomized glue to the wood fibers forming the curtain, the pressurized glue being conveyed to and emitted from each nozzle at a pressure of from about 15 bar to about 250 bar and a flow of more than 1 liter/minute.

17. Method according to claim 16, wherein said glue is pressurized to a pressure of from about 40 bar to about 90 bar.

18. Method according to claim 17, further including the step of providing a high-pressure pump having an adjustable rotational operating speed for varying the pressurization of said glue, and adjusting the pump speed and pressurization of the glue.

19. Method according to claim 16, wherein said glue is a glue-water mixture and said glue-water mixture is atomized, the proportion of glue being 45% to 60% by weight.

20. Method according to claim 19, wherein said proportion of glue is 50% to 60% by weight.

21. Method according to claims 19 or 20, wherein said glue is entirely or predominantly a urea resin.

22. Method according to claim 16 or 19, further including pressing the wood fibers provided with glue to form a board having a thickness of not more than 10 mm.

23. Method according to claim 22, further including providing a calendar press, and pressing the wood fibers with said calendar press to form said board.

24. Apparatus for performing the method according to claims 16 or 19, comprising means for forming the curtain of wood fibers, means for conveying and pressurizing said glue, nozzles for atomizing the conveyed glue, and a high-pressure pump for nebulizing glue, said high-pressure pump having an adjustable rotational operating speed.

25. Apparatus according to claim 24, wherein said nozzles are arranged in a semi-circle for emitting nebulized glue and supplying nebulized glue into a mixer which is provided for mixing the nebulized glue and the wood fibers.

26. Apparatus according to claim 25, further comprising a calendar press for pressing the wood fibers provided with glue to form a board.

27. Apparatus according to claim 26, further comprising a flow rate meter for measuring and/or controlling the amount of glue applied to the wood fibers.

28. Apparatus according to claim 27, further comprising air means for supplying compressed air to said high-pressure nozzles.

29. Apparatus according to claim 28, further comprising water means for supplying warm water to be mixed with said glue to form said glue-water mixture.

30. Apparatus according to claim 29, further comprising a bypass line for supplying glue to said nozzles in parallel with said flow rate meter.

31. Apparatus according to claim 30, further comprising stop valves for controlling and/or dosing the supply of glue, warm water and/or compressed air.

32. Apparatus according to claim 31, further comprising a device for closing said high-pressured nozzles.

33. Apparatus according to claim 32, wherein said air means, water means, bypass line and valves are designed to resist a pressure of up to 100 bar.
